(19) United States
(12) Patent Application Publication
(10) Pub. No.: US 2007/0094304 A1
(43) Pub. Date: Apr. 26, 2007

(54) Associating subscription information with media content

(76) Inventors: Richard Mark Horner, Cary, NC (US); Jeffrey Scott Bardsley, Durham, NC (US); Robert P. Morris, Raleigh, NC (US)

Correspondence Address: SCENERA RESEARCH, LLC, 111 Corning Road, Suite 220, Cary, NC, 27518, US

(21) Appl. No.: 11/241,162

(22) Filed: Sep. 30, 2005

(51) Int. Cl. G06F 17/00; G06F 7/00

(52) U.S. Cl. 707/104.1

(57) ABSTRACT

A computer-implemented method and system is provided for associating subscription service information with media content. An exemplary embodiment includes receiving the media content including an identifier of a subscription service associated with the media content; using the identifier to subscribe to a subscription service using a publish/subscribe protocol; receiving information associated with the subscription service via the publish/subscribe protocol based on the subscription; and presenting the subscription information along with the media content.

### CROSS-REFERENCE TO RELATED APPLICATION

The present invention is related to co-pending U.S. patent application Ser. No. 11/170,709 entitled “Associating Presence Information with a Digital Image,” (3611P/1330) filed on Jun. 27, 2005 which is assigned to the assignee of the present application and herein incorporated by reference.

### TECHNICAL FIELD

The present invention relates to media content, and more particularly to a method and system for associating subscription information with media content.

### BACKGROUND

Media player applications capable of playing audio, video, streaming formats and many other popular audio and video formats are widespread. Examples of well-known media players include WINDOWS MEDIA PLAYER from MICROSOFT, QUICKTIME from APPLE COMPUTER, and REALONE and REALPLAYER from REALNETWORKS.

During playback of media content comprising video, audio, or both, the media player may display attributes associated with the content, such as title, artist, album, rating, genre, track, bit rate, and so forth. However, while viewing/listening to the content, it would be beneficial to users to be notified whether entities associated with the content are available for communication. Existing media player applications fail to provide this functionality.

### SUMMARY

A computer-implemented method and system is provided for associating subscription service information with media content. An exemplary embodiment includes receiving media content including an identifier of a subscription service associated with the media content; using the identifier to subscribe to a subscription service using a publish/subscribe protocol; receiving information associated with the subscription service via the publish/subscribe protocol based on the subscription; and presenting the subscription information along with the media content.

According to the method and system disclosed herein, by providing the subscription information to a viewer/listener in conjunction with the media content, the viewer/listener is thereby informed of entities associated in some way with the media content and whether or not those entities are available for communication. If the presence information includes status, then the viewer is informed whether the identified object is available for real-time communication.

### BRIEF DESCRIPTION OF SEVERAL VIEWS OF THE DRAWINGS

FIG. 1 is a block diagram illustrating a system for associating presence information with media content in accordance with an exemplary embodiment.

FIG. 2 is a flow diagram illustrating a process for associating subscription information with media content in accordance with an exemplary embodiment.

FIG. 3 is a diagram illustrating an example ID3v1 tag with the subscription identifier.

FIG. 4 is a diagram illustrating an example CD text file with multiple subscription identifiers.

FIG. 5 is a diagram illustrating an example MPEG-2 transport stream with the subscription identifier.

FIG. 6 is a diagram illustrating an example display of subscription information that is associated with the media content as the media content is played.

### DETAILED DESCRIPTION

The present invention relates to associating subscription information with digital media content. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The preferred embodiment provides a method for associating presence/status information with media content to enable consumers to subscribe to information related to the media content. The exemplary embodiment makes use of a publish/subscribe communication architecture to allow consumers to subscribe to information corresponding to tags or identifiers embedded in the media content. Such information may be broadly referred to as subscription information, which may include presence information. In one preferred embodiment, the identifier may be used to obtain the presence status of the entities that created, contributed to, sent, or received the media content. The presence information may then be used when the media content is played to indicate not only who the people are (in the case where the entities are people), but also whether any of the people are available for communication, including real-time communication via chat or telephone, and/or non-real-time communication via e-mail or postage.

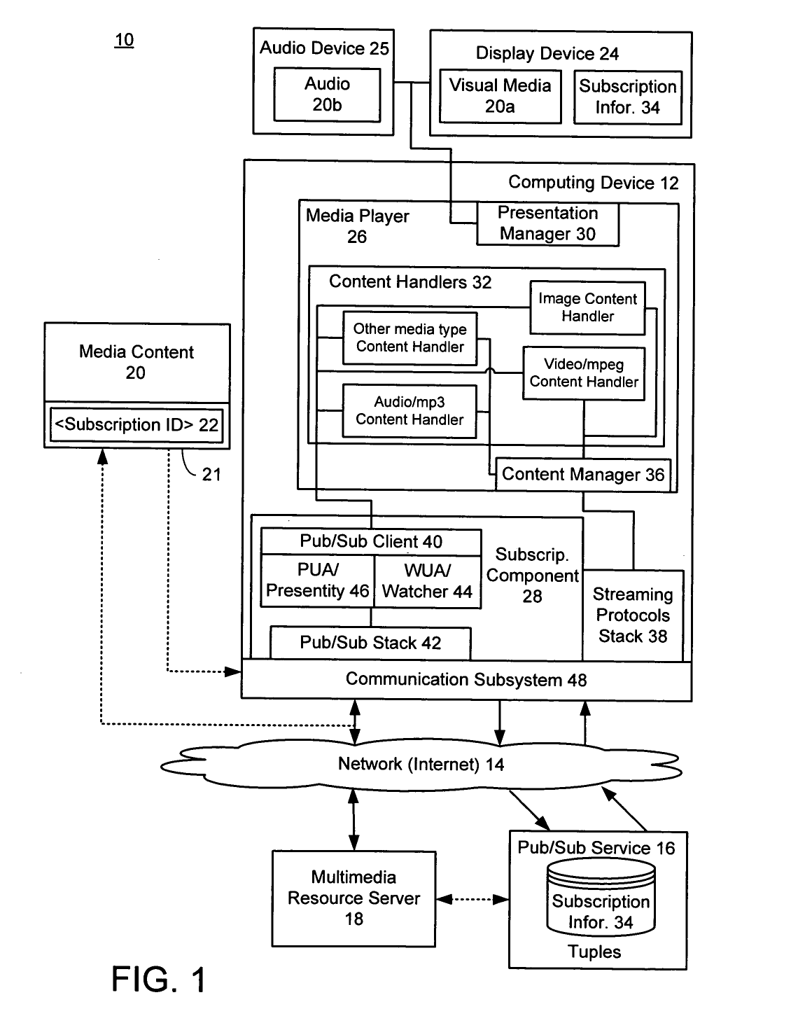

FIG. 1 is a block diagram illustrating a system for associating subscription information with media content in accordance with an exemplary embodiment. The system 10 includes one or more computing devices 12 in communication with a publication/subscription (pub/sub) service 16 and an optional media resource server 18. Although a publication/subscription service 16 is shown, it should be understood that the publication functionality of publication/subscription service 16 is not necessarily required and may be omitted such that only subscription functionality is employed at the publication/subscription service 16. The computing device 12 may be any electronic device that includes a communication subsystem 48 for communicating over a network 14, and a media player 26 for playing media content 20 over an audio output device 25 and/or a display device 24. Example types of such computing devices include a cell phone, a personal digital assistant (PDA), a personal computer (PC), a game player, and the like. Examples of the display device 24 may include an attached or detached LCD, OLED, Plasma, or a projector, and example types of communication subsystems 48 include Ethernet, wireless, or a dial-up connection, which may access the network 14 (Internet) through a LAN or WAN.

The media player 26 may comprise software that plays media content 20, including one or more of audio, video, streaming formats, as well as many other popular audio and video formats, including, MP3, CD audio and MIDI files. The media content 20 played by the media player 26 represents digital media comprising video 20a, audio 20b, or both, that resides on some type of media (e.g., a hard drive, CD, DVD, etc.), or is streamed over the network 14 from a source such as the media resource server 18.

The media player 26 includes a presentation manager 30, one or more content handlers 32, and a content manager 36. Each of the content handlers 32 can process information related to the media content 20 and other content received by the computing device 12 based on a respective type the information in the received content. The information type can be any of the available MIME types, such as the “image/jpeg”, “video/wmv”, and “audio/midi”, “txt/html” types, for instance. The content manager component 36, which is coupled between a streaming protocol stack 38 and the content handlers 32, can be configured to route the information related to the content received via the stack 38 from the network 14 to at least one of the content handlers 32 based on the type (e.g., the MIME type) of the information and other content received. Based on the type of content received from the content handlers 32, the presentation manager 30 presents the media content 20 by sending visual media 20a to the display device 24 and by sending audio 20b content to the audio device 25.

The computing device 12 is further provided with a subscription component 28 that utilizes subscription information and accesses the pub/sub service 16. The pub/sub service 16 (or alternatively, subscription service 16) accepts information, stores subscription information 34 and distributes the subscription information 34 to requesting services, including the subscription component 28.

According to the preferred embodiment, the content handlers 32 are adapted to read a subscription identifier 22 embedded in the media content 20 and to provide the subscription identifier 22 to a subscription component 28. The subscription component 28 is capable of communicating with the pub/sub service 16 using a publish/subscribe protocol in order to subscribe to the subscription information 34 corresponding to subscription identifier 22, and to make the subscription information 34 available to a user when the media content 20 is played, as explained below.

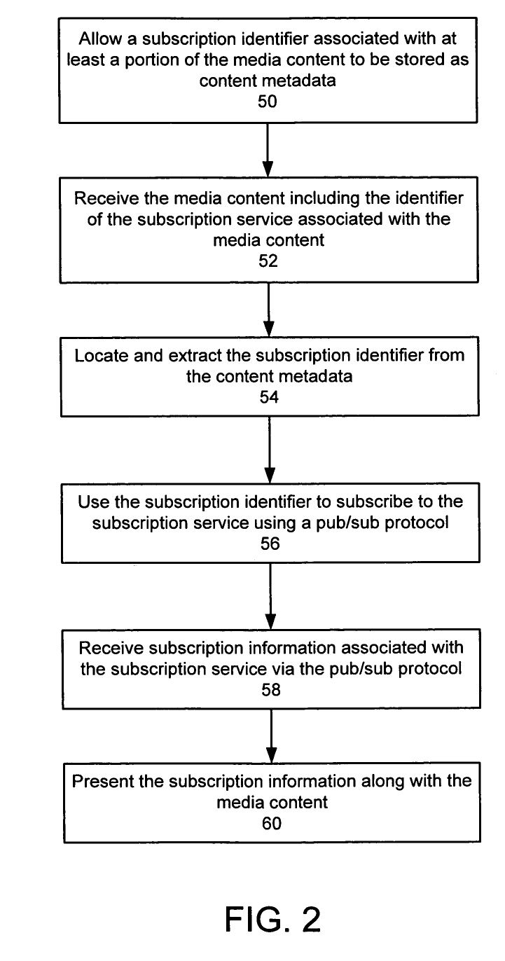

FIG. 2 is a flow diagram illustrating a process for associating subscription information 34 with media content 20 in accordance with an exemplary embodiment. Referring to both FIGS. 1 and 2, the process begins in step 50 by allowing the subscription identifier 22 associated with at least a portion of the media content 20 to be stored as content metadata 21. In a preferred embodiment, the subscription identifier 22 may include a Uniform Resource Locator (URL) or a Uniform Resource Identifier (URI) used to describe and/or identify a network resource, object or other means of indicating a point of contact, such as names, telephone numbers, email addresses, postage address. According to the exemplary embodiment, the subscription identifier 22 may identify the subscription service 16 and the media content 20. In some contexts, the subscription identifier 22 may include information that is not intended for the public, such as employee and account numbers, for example. Alternatively, the subscription identifier 22 can be a link that is associated with a URI corresponding to subscription information 34 related to the media content 20.

Although only one subscription identifier 22 is shown, the media content 20 may include multiple identifiers 22 that are associated with multiple entities related to the media content 20 or associated with multiple portions of media content 20. In one embodiment, the metadata 21 may be populated with the subscription identifier 22 by a provider of the media content 20 (e.g., a creator or distributor), the subscription service 16, or both.

The subscription identifier 22 may be embedded as media content metadata 21 using a variety of methods depending on the type and format of the media content 20. For example, for audio content, the subscription identifier 22 may be stored in an ID3 tag, which provides a mechanism for saving information about the contents of an audio file. For media content 20 in a conventional Compact Disk Digital Audio format, the subscription identifier 22 may be stored as CD text. For media content 20 in MIDI format, the subscription identifier 22 may be stored in a MIDI field, such as a text event field. For media content 20 that comprises both audio and video data in Motion Pictures Expert Group (MPEG) format, the subscription identifier 22 may be inserted into an MPEG transport stream packet.

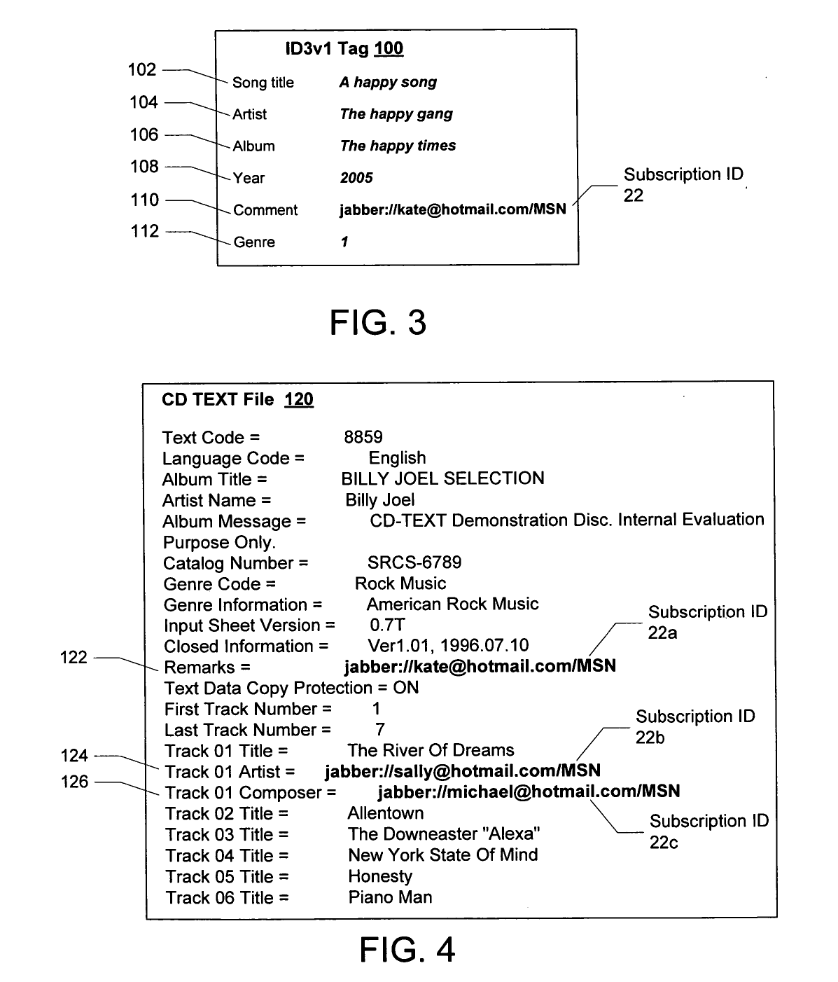

FIG. 3 is a diagram illustrating an example ID3vl tag with the subscription identifier 22. An ID3v1 tag 100 has a fixed size of 128 bytes for ease of detection during audio playback (see http://www.id3.org/id3v1.html). The tag 100 comprising a 30 character song title 102, a 30 character artist 104, a 30 character album 106, a 4 character year 108, a 30 character comment 110, and a one byte genre 112. In a preferred embodiment, the subscription identifier 22 is stored in the comment 110, as shown.

The subscription identifier 22 can be extracted by using known methods of identifying email addresses, URLs, IP addresses and telephone numbers in normal text. Also, an ID3 tag 100 can be dedicated to include just the subscription identifier 22 alone. Newer versions of ID3, including ID3v2 (http.//www.id3.org/id3v2.3.0.html) provide more tags and allow for the creation of custom tags, including tags that are designed to include URLs and email addresses, referred to as a user defined URL link frame.

FIG. 4 is a diagram illustrating an example CD text file 120 with multiple subscription identifiers 22a, 22b and 22c. Information included in the CD text file 120 includes the title of the CD, artist name, titles of individual tracks, genre information, songwriters, performers, composers, the arrangers involved in the music, and the like. In this example, the subscription identifier 22a is associated with the whole album and is stored in a remarks field 122, the subscription identifier 22b is associated with the artist of track 01 and stored is the track 01 artist field 124, and subscription identifier 22c is associated with the composer of track 01 and stored in the track 01 composer field 126.

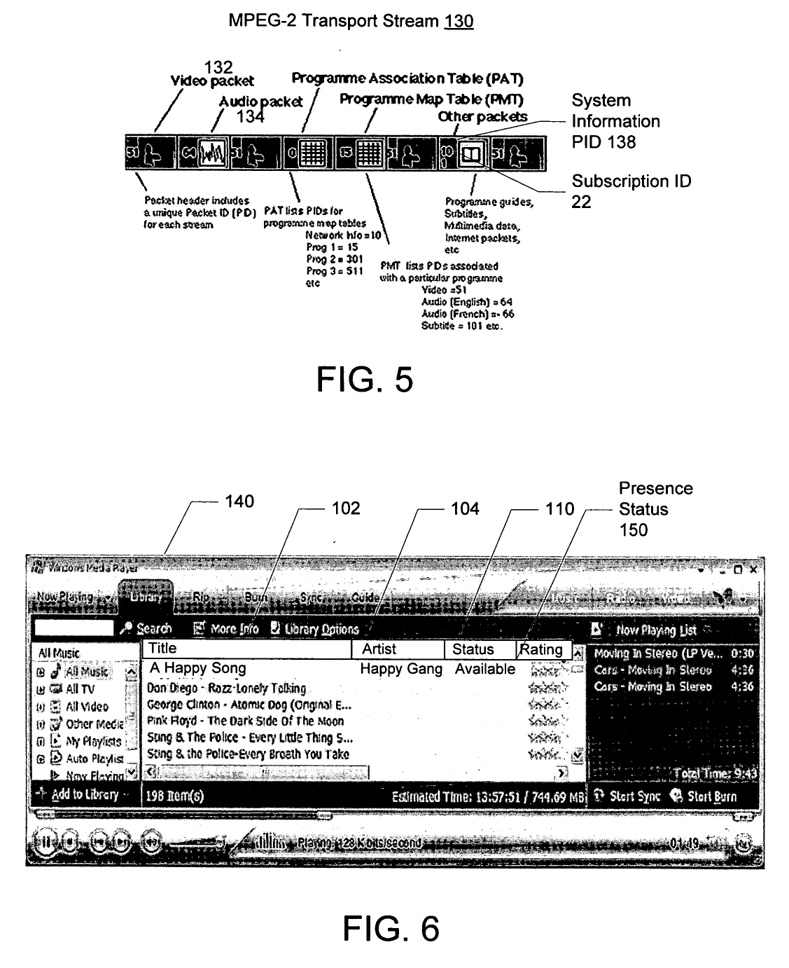

FIG. 5 is a diagram illustrating an example MPEG-2 transport stream 130 having the subscription identifier 22. The MPEG-2 transport stream 130 has video, audio, and system information packets 132, 134, and 136, respectively, which are identified by three different types of packet identifiers (PIDs). In a preferred embodiment, the subscription identifier 22 is embedded in a system information PID 138.

Referring again to FIG. 2, after the media content 20 and the subscription identifier 22 are made available to a user, in step 52, the computing device 12 receives the media content 20 including the identifier 22 of the subscription service 16 associated with the media content 20. In step 54, the content manager 36 locates and extracts the subscription identifier 22 from the content metadata 21. Locating and extracting the subscription identifier 22 may include the following steps: determining the type of metadata content, determining the type of metadata 21, determining the version of the metadata 21 (e.g., ID3v1 or ID3v2), searching for subscription identifiers 22 in the appropriate metadata tags, determining the types of subscription identifiers 22 that can be stored in the metadata 21 (e.g., URL, email, IP address), determining any encoding of subscription identifiers 22 that can be stored in the metadata 21 (e.g., binary, HEX, ASCII, BASE64), and determining the format of the subscription identifier 22 (e.g., jabber://kate@hotmail.com/MSN, 919-555-1234). In one embodiment, the subscription identifier 22 is extracted when the media player 26 receives a request to play the media content 20. In another embodiment, the subscription identifier 22 is extracted when the computing device 12 receives the media content 20.

In step 56, the subscription component 28 uses the subscription identifier 22 to subscribe the computing device 12 to the subscription service 16 using a publish/subscribe (pub/sub) protocol. In step 58, the subscription component 28 receives the subscription information 34 associated with the subscription service 16 via the pub/sub protocol.

More specifically, the subscription component 28 includes a pub/sub client 40 and a pub/sub stack 42. The pub/sub client 40 includes a watcher user agent (WUA) 44 and an optional presentity user agent (PUA) 46. The WUA/watcher 44 may be configured to receive the subscription identifier 22 extracted from the media content 20 and use the pub/sub stack 42 to send a request to the subscription service 16 for a subscription to one or more tuples containing the subscription information 34 associated with the one or more corresponding subscription identifiers 22 extracted from the media content 20.

The pub/sub stack 42 is coupled to the pub/sub client 40 and is configured to allow the WUA/watcher 44 to request the subscription to the tuple associated with the subscription service 16 and receive the subscription information 34 related to the media content 20. As understood by those skilled in the art, the pub/sub stack 42 is used to exchange information received or transmitted at the physical layer (e.g., the wire, air interface, or fiber optic cable) of the network 14, through data link (e.g., ETHERNET, 802.11 WIFI), transport/network (e.g., TCP/IP) and application layers of the stack. The pub/sub stack 42 may be implemented using “Extensible Messaging and Presence Protocol (XMPP), although other protocols may be employed, such as a protocol stack supporting Session Initiation Protocol (SIP) for Instant Messaging and Presence Leveraging Extensions (or SIMPLE) or alternatively, any CPP compliant protocol stack as specified in RFC 3859.

The PUA/presentity 46 may be configured to publish information to the subscription service 16 related to a user of the device 12 (i.e., the consumer/receiver of the media content 22). For example, the PUA/presentity 46 can be configured to publish the presence ID of the user to the subscription service 16 to advertise that the user and/or the device 12 are subscribed to the tuple associated with the media content 20. The presence service 16 can then send this information to other subscribers pursuant to their subscriptions to the presence tuple. The subscription service 16 can be hosted on a standalone server (as shown), on a number of servers arranged throughout the network working, on the resource server 18, or any combination of dedicated subscription servers and resource servers 18.

In FIG. 1, the content handlers 32 are shown sharing the PUA/Presentity 46 for publishing and sharing the WUA/Watcher 44 for subscribing and receiving notifications. In other embodiments, each of the content handlers 32 could provide its own PUA or WUA and share a presentity and/or a watcher, or each could provide their own presentity and watcher, and, of course, all other combinations apply as well.

When a content handler 32 finds a subscription identifier 22 in the media content 20, the media player 26 determines whether to subscribe, and how and when to present the subscription information 34. The decision is application or feature specific, as described by way of user scenarios below.

In a preferred embodiment, using the subscription identifier 22 to subscribe to the subscription service 16 comprises using the identifier 22 to retrieve presence information associated with the media content 20. Presence information is a subset of subscription information that includes a status ID in addition to other optional information, such as contact information, which may include contact addresses and contact means. As is well-known in the art, presence is a medium of communications over a network that is a means for finding, retrieving, and subscribing to changes in the presence information (e.g., “online” or “offline”) of other principals (i.e., real-world objects such as people or programs) where each of these principals users has presence information associated with them. In this embodiment, the subscription identifier 22 may be used to determine the presence of a creator, contributor, a sender, or other receivers of the media content 20.

As described in A Model for Presence and Instant Messaging (RFC 2778) and Instant Messaging/Presence Protocol Requirements (RFC 2779) published by the IMPP WG, the format of the presence information may include an arbitrary number of elements, called presence tuples. Each presence tuple includes a status that conveys status information (such as online, offline, busy, away, do not disturb) of a particular principal/presentity (e.g., user), an optional communication address, and optional other presence markup. A communication address includes a contact means and a contact address. One type of contact means is instant message service, where the corresponding contact address is an instant inbox address. However, a contact means may also indicate one or more of the following: some form of telephony, for example, with a corresponding contact address containing a telephone number; email communications with a corresponding contact address containing an email address; or a physical mail service with a corresponding contact address containing a postal address. Thus, broadly speaking, the presence information includes general contact information for the principal, such as name, telephone number, email address, postal address, and IP addresses or URLs associated with the object, and the like. If the presence information associated with an object does not include a status, then the presence information is considered subscription information 34 that may contain general contact information or any other information related to the subscription ID.

In a preferred embodiment, the subscription identifier 22 is used to associate presence information with the identified object when the corresponding media content 20 is accessed as follows. Referring to FIG. 1, when the media player 26 plays the media content 20, one of the content handlers 32 parses the metadata 21 and extracts any subscription identifiers 22 found. The content handler 32 then determines whether the subscription identifier 22 is a type sufficient to directly obtain the presence information associated with the media content 20 (e.g., a presence URL). In addition, the content handler 32 examines the computing device configuration and determines the most appropriate method to obtain presence information associated with the content 20 based on the computing device configuration and the type of subscription identifier 22.

If the subscription identifier 22 is a type sufficient to directly obtain the presence information associated with the content 20 (e.g., is a presence URL), then the subscription identifier 22 is used to associate the presence information with the content 20. For example, the content handler 32 can send the subscription identifier 22 to the pub/sub client 40 and the pub/sub client 40 uses the subscription identifier 22 to subscribe to a subscription service 16 (e.g., presence service) to obtain the subscription information 34 (e.g., presence information, which may include presence status and/or contact information, as explained above).

If the subscription identifier 22 is not a type sufficient to directly obtain the subscription information associated with the identified object (e.g., is not a presence URL), then the subscription identifier 22 is used as an index to retrieve the presence URL from a cross-reference database, and the presence URL is then used to obtain the presence information, as explained above. For example, if the subscription identifier 22 is a telephone number, contact address, name, or other form of identifier, then that identifier can cross reference to a subscription identifier (e.g., presence URL) by accessing a cross-reference database. For example, subscription component 28 can access a cross-reference database (not shown) via communication subsystem 48 and network 14. The cross-reference database may be a separate entity or may be included in, or associated with, the pub/sub service 16.

One example of a database that may be used is an ENUM (Electronic NUMbering) database. ENUM is a protocol from the IETF for formatting an international telephone number (E.164) so that it can be resolved in the Internet's DNS system. ENUM transforms a phone, fax, or pager number into a dotted Internet address that is stored in the domain name system (DNS) system. For example, the fully qualified telephone number 1-215-555-1234 would turn into 4.3.2.1.5.5.5.5.1.2.1.e164.arpa. The digits are reversed because DNS reads right to left. DNS can then be used to cross-reference other information related to the telephone number, which is stored in naming authority pointer records (NAPTR). The information can include various forms of information, including a URL pointing to subscription information. An exemplary NAPTR record format including a URL pointing to subscription information that may be used is shown below:

$ORIGIN 2.4.2.4.5.5.5.1.e164.arpa.

IN NAPTR 100 10 “u” “pub/sub” “pub-sub://kate22@pub-sub8002.com”

The above example uses the URL “pub-sub://kate22@pub-sub8002.com” to access subscription information in the pub/sub service 16. Many other forms of URL's, or pointers in general, may be used to access subscription information in the pub/sub service 16.

Although an ENUM database has been described in the example above, it will be understood that any database that can be accessed to cross-reference from a subscription identifier 22 that is not a type sufficient to directly obtain the subscription information from the pub/sub service 16 to a URL that is sufficient to directly obtain the subscription information.

Prior to performing the cross reference operation, the subscription identifier 22 can be validated to ensure that the format of the data is correct. For example, if the content handler 32 determines that the subscription identifier 22 is a telephone number, then the subscription component 28 or some other component can validate that the telephone number has a valid prefix area code and/or the requisite number of digits.

Referring again to FIG. 2, after the subscription component 28 receives the subscription information 34 from the subscription service 16, in step 60, the subscription information 34 is presented along with the media content 20. More specifically, the subscription information 34 sent by the subscription service 16 is received by the pub/sub stack and passed to the WUA/watcher 44. The WUA/watcher 44 passes the subscription information 34 to the media player 26, and the presentation manager 30 presents the subscription information 34 as the media content 20 is played.

In a preferred embodiment, the action performed includes determining the presence of a creator, contributor, a sender, or other receivers of the media content 20; displaying the subscription information 34 with the media content 20 on the display device 24; printing the subscription information 34 with the media content 20; or playing an audio reproduction of the content of the subscription information 34 on the audio device 25.

FIG. 6 is a diagram illustrating an example display of subscription information 34 that is associated with the media content 20 as the media content 20 is played. In this example, a media player 140 is playing audio data from the media content shown in FIG. 3. The identifier 22 shown in the comment 110 of FIG. 3 has been used to retrieve and display subscription information 34, in this case presence status 150 of the entity associated with the identifier 22, along with the other information in the ID3 tag while the audio is played. In this example, the Title and Artist information from the title and artist fields 102 and 104 are displayed for the current track, along with the presence status 150 retrieved using the identifier 22 form the comment field 110.

According to the preferred embodiment, by providing the subscription information 34 to a viewer in conjunction with the media content 20, the viewer is thereby informed of entities associated in some way with the media content 20 and whether or not the entities are available for communication. If the presence information includes status, then the viewer is informed whether the identified object is available for real-time communication.

The presence information may be displayed in a variety of ways. In one embodiment, the subscription information 34 may be displayed next to the media content 20. In another embodiment, the subscription information 34 may be displayed in a window separate from the media content 20. Also, presence information from several subscription identifiers 22 may be displayed as a group or with the corresponding portions of the media content, (e.g., displaying subscription information 34 associated with individual tracks when each track is played).

In a further embodiment, the action performed related to the object using the associated subscription information 34 includes opening a communication channel via the communication address associated with the object. After the subscription information 34 is displayed, the user can manually contact the identified object by bringing up a communication method of choice, such as instant messenger, using any contact addresses displayed. Or the subscription component 28 can be configured to automatically start a default communication method using communication means included in the computing device 12, such as invoking the instant messenger application when a user clicks on the presence status and opening a communication channel to the identified object using the communication subsystem 48. In another embodiment, a viewer may click on the displayed subscription information 34, which in turn, brings up a menu showing the connection options, such as email, chat, or phone.

Several user scenarios are provided below to further illustrate operation and advantages of the system 10 for associating subscription information 34 with media content 20.

Scenario 1—Determining the presence of a creator of the content.

Sally is listening to a music track on her PC. She clicks on an mp3 music track recorded by her sister Kate. The audio application extracts the email address i.e. kate@hotmail.com (or presence URL, see Jabber specs i.e. jabber://kate@hotmail.com/MSN) of Kate from the ID3v2 audio metadata and connects to a presence service to check Kate's presence status. The presence service indicates that Kate is “Available” and can be contacted by chat or email. The audio application displays a green icon to show that she is “Available”. Sally sees that Kate is available and clicks on the green icon, which brings up a menu showing the connection options of email or chat. Sally selects chat, so the audio application starts the default chat application on the PC and instructs it to start a new chat session using Kate's email address as the person to contact. Sally and Kate then chat.

Scenario 2—Determining the presence of a sender of the content.

Sally is listening to an audio stream over the internet from a radio station on her PC. The presence ID of the radio station is included in the metadata of the audio. The audio application extracts the presence ID from the audio stream's metadata and uses a built-in presence component to subscribe to the radio stations presence information. The presence information includes a URL to a lyrics service that provides lyrics for the audio being streamed. The audio application subscribes to this service and receives the lyrics for each song and displays them in a window. Sally sings along to all her favorite music.

Scenario 3—Determining the presence of a subset of the receivers.

Sally is watching a streamed movie over the internet on her PC. The presence ID's of all those people subscribed to the streamed movie are included in the metadata during the commercials. The movie viewing application extracts the presence ID's and compared those with the presence ID's on Sally's buddy list. The application finds that Sally's sister Kate is subscribed to the movie, so it retrieves her presence information and displays her name and presence status in a window next to the movie. During the next commercial Sally sees Kate is subscribed to the movie and that her status is “Available”. So she clicks on Kate's name which opens a chat window so she can chat with her about the movie.

Scenario 4

Eric is listening to a music track made by his family on his mobile phone. Eric presses the “Determine Status” key on his phone. The phones audio application extracts the telephone numbers from the audio metadata and adds them as contacts to the phones presence application. The audio application requests the presence for all the telephone numbers in the audio track from the presence application. The audio track contains metadata that describes for each telephone number the location in the audio track that the person contributed. So the audio application combines the track location information with presence to dynamically display the presence status indicator over the audio track time-line only when they are playing. So for those who are available, the word “Available” appears over the location in the audio track.

Scenario 5

Michael is listening to an audio track on his family web site. The web site looks at the metadata of all the audio tracks and extracts emails address, telephone numbers, IP addresses and screen names. It uses a built-in presence service to obtain the presence and location of all the contacts. The family site shows Michael all the tracks in his album and a consolidated list of all the contacts with presence and location. He sees that his friend John is “Available” and his location is “Ilkley, UK”. He also sees that John's guitar Plucky is “Available” and it's located in “Ilkley, UK”. He decides to telephone John and ask him to record some more music on Plucky and it on the web site.

Scenario 6

Jean is listening to music from a band. She selects the audio track and selects the “Determine Presence” option. The audio track application has no presence ID, so the audio application connects to a music identification service like www.shazam.com that can identify an audio track from the music itself. The music identification service recognizes the music as one by The Beatles. The audio application then performs a search of a contact database on the internet using “The Beatles” to retrieve the bands email addresses. The application then passes the email addresses to a presence service and the application retrieves the presence information for The Beatles. The application highlights the music track with the presence information “Unavailable” as the band is no longer together, but Sir Paul McCartney is “Available” and “In Concert, NY, USA”. The audio application also updates the audio track metadata with the presence ID's and presence information.

Scenario 7

The Musician-On-Time agency operates a session musician agency. The agency web site contains a catalogue of music tracks from the musicians available. Chuck is the employee in charge of the agency web site and decides to utilize a new technology which can include presence in relation to an audio track. Chuck wants to combine this technology with the instant messenger addresses of the musicians and the audio tracks on the agency web site. The musicians are specialized in handling various types of music. Bob Smith handles all rock while Jane Doe is responsible for all jazz. Chuck's intention is to allow customers who visit the web site to click on an audio track and be connected to the musician via instant messenger chat. Now customers can be in direct communication with a musician who can best answer questions in relation to the music requirements.

The agency has worked on a new rock album, so Chuck takes an audio track and loads it into an audio editor. In the editor, he uses the audio metadata editor to create a tag called “Musician Presence Id” and assigns it the presence URL of Bob Smith (jabber://bob.smith@musician-on-time.com/IM) the musician on the album. He also adds the presence URL to the standard ID3v2 tag TOPE (The ‘Original artist(s)/performer(s)’ frame is intended for the performer(s) of the original recording). Chuck uploads the audio track to the agency web site.

Jake Fat Fingers is a customer looking to record a new rock album, so he checks the Musician-On-Time web site. Finding the rock album, he clicks on a track. His web browser searches all the audio metadata looking for a presence URL, it finds one for Bob Smith. The browser makes a request to the Musician-On-Time presence server for Bob Smith's presence information. The presence server returns his status as “Available”, so the browser displays a green icon on the rock album audio track. Jake Fat Fingers has a question about the guitar playing, so he clicks on the green icon and the browser uses the presence URL to start a chat session between Jake Fat Fingers and Bob Smith. Jake Fat Fingers sends a message asking if Bob can play Jimi Hendrix. Bob Smith replies that he loves Jimi Hendrix, so Jake Fat Fingers places a request for Bob Smith with the agency.

Scenario 8

Richard is attending a party with his friends Scott and Mona. Richard plays a music track from his favorite band on his mobile phone. While the track is playing, his mobile phone uses Bluetooth to detect the presence of mobile device nearby. It finds the mobile phones of Scott and Mona, then obtains both their email addresses. Then the mobile phone application adds those email addresses to the audio metadata for the currently playing music track.

One year later Richard is waiting for a flight and decides to listen to some music. He selects the same audio track and begins listening. Then he thinks, I remember the last time I heard this I was at a party, now who was there again?

Richard presses the “Remember” button on the mobile phone. The phone's audio application extracts the email addresses from the audio metadata and requests the presence status from the phones buddy list. The audio application displays the presence status, showing both Scott and Mona as “Available”. Richard selects both their names and the mobile phone starts a conference call between Richard, Scott and Mona.

Scenario 9

The “Rock Band” has just released a new album and is about to go on tour. As part of the promotion, they decide to release several new songs on the music service site called Rhapsody. The Rhapsody technical people work with the “Rock Band” and explain that the audio files that will be made available to the public can have presence information embedded. It is as simple as using a file editor to add presence information and link that to the company's presence server and Ticket Master's web site. The Rhapsody representative goes on to explain that this can be used to help promote the bands tour by updating the files with pertinent location information as the tour progresses. The technology will enable a correlation between the end users location and where the Rock Band will be performing next. This will work by collecting the end user's IP address when they log onto Rhapsody with a client and then comparing this information with the presence information in the audio track. The band decides to go ahead and try this new technology. The new songs are then made available through Rhapsody's service.

Meanwhile, Joe User logs into Rhapsody and sees the newly released songs from the Rock Band. As Joe is logged-in, his Rhapsody client was updated to be able to process audio files which contain presence information. Now that Joe is logged-in, the Rhapsody client requests its location from the Rhapsody server. The Rhapsody server knows the IP address of the client because of its current connection and uses an IP geo-location cross-reference database service that cross-references an IP address to a physical location. Next it returns the location to the client which determines that Joe is in Las Vegas, Nev. Joe starts to play the first new song released by the Rock Band. The Rhapsody client looks at the presence information in the track that Joe is playing and recognizes a match between Joe's location and that the Rock Band will be performing in Las Vegas next month. This information is then displayed for Joe in the client and offers him a link to click on for details about the show and how to get tickets.

A method and system for associating description service information with media content has been disclosed. The present invention has been described in accordance with the embodiments shown, and one of ordinary skill in the art will readily recognize that there could be variations to the embodiments, and any variations would be within the spirit and scope of the present invention. For example, the viewer may be required to be authenticated for obtaining presence information (e.g., by entering a username and password). Accordingly, many modifications may be made by one of ordinary skill in the art without departing from the spirit and scope of the appended claims.

We claim:

1. A computer-implemented method for associating subscription service information with media content, comprising:
receiving the media content including an identifier of a subscription service associated with the media content;
using the identifier to subscribe to the identified subscription service using a publish/subscribe protocol;
receiving information associated with the subscription service via the publish/subscribe protocol based on the subscription; and
presenting the subscription information along with the media content.

2. The method of claim 1 wherein the identifier is associated with at least a portion of the media content.

3. The method of claim 2 wherein using the identifier further includes:
using the identifier to associate subscription information with the portion of the media content; and
performing an action related to the portion of the media content using the associated subscription information.

4. The method of claim 1 wherein the subscription information includes presence information.

5. The method of claim 1 further including: using a plurality of identifiers for associating respective subscription information with the media content.

6. The method of claim 1 further including: receiving the media content with multiple identifiers corresponding to people subscribed to the media content.

7. The method of claim 1 wherein the media content includes at least one of audio data and video data.

8. The method of claim 7 wherein the identifier is stored in an ID3 tag.

9. The method of claim 7 wherein the identifier is stored as compact disc text.

10. The method of claim 7 wherein the identifier is stored in a MIDI field.

11. The method of claim 7 wherein multiple identifiers are associated with individual parts of the media content.

12. The method of claim 11 wherein the multiple identifiers are associated with individual tracks of the audio data.

13. The method of claim 7 wherein the media content is multimedia content comprising both audio and video data and the identifier is inserted into an MPEG transport stream packet.

14. The method of claim 1 wherein the subscription information includes at least one of:
subscription information of a creator of the media content;
subscription information of a contributor of the media content;
subscription information of a sender of the media content; and
subscription information of at least a subset of receivers of the media content.

15. The method of claim 14 wherein presenting the subscription information along with the media content includes at least one of displaying the subscription information associated with the media content in response to a request to play the media content, printing the subscription information, and playing an audio reproduction of content from the subscription information while the media content is played.

16. The method of claim 7 wherein the media content includes audio data having multiple tracks and multiple identifiers stored in the metadata are associated with respective tracks, the method further including presenting subscription information associated with each of the tracks when each of the tracks is played.

17. The method of claim 1 wherein the subscription information includes at least one of a status that conveys status information and a communication address.

18. The method of claim 17 wherein the communication address specifies at least one contact means and at least one corresponding contact address associated with the subscription information.

19. The method of claim 17 further comprising automatically opening a communication channel via the communication address associated with the subscription information.

20. The method of claim 3 wherein using the identifier to associate subscription information with the media content and performing an action related to the portion of the media content includes using the identifier as an index to retrieve a subscription URL from a cross-reference database if the identifier is not of a type sufficient to directly obtain the subscription information, and then using the subscription URL to obtain the subscription information.

21. A system for associating subscription service information with media content, comprising:
a computing device for receiving the media content including an identifier of a subscription service associated with the media content;
a publish/subscribe client coupled to the computing device, the publish/subscribe client for using the identifier to subscribe to a subscription service using a publish/subscribe protocol, and for receiving information associated with the subscription service via the publish/subscribe protocol based on the subscription; and
a media player coupled to the computing device for playing the media content and for presenting the subscription information along with the media content.

22. The system of claim 21 wherein the identifier is associated with at least a portion of the media content.

23. The system of claim 22 wherein the publish/subscribe client uses the identifier to associate subscription information with the portion of the media content; and wherein an action is performed related to the portion of the media content using the associated subscription information.

24. The system of claim 21 wherein the subscription information includes presence information.

25. The system of claim 21 wherein the media content includes a plurality of identifiers for associating respective subscription information with the media content.

26. The system of claim 21 wherein the media content includes multiple identifiers corresponding to people subscribed to the media content.

27. The system of claim 21 wherein the media content includes at least one of audio data and video data.

28. The system of claim 27 wherein the identifier is stored in an ID3 tag.

29. The system of claim 27 wherein the identifier is stored as compact disc text.

30. The system of claim 27 wherein the identifier is stored in a MIDI field.

31. The system of claim 27 wherein multiple identifiers are associated with individual parts of the media content.

32. The system of claim 31 wherein the multiple identifiers are associated with individual tracks of the audio data.

33. The system of claim 27 wherein the media content is a media file comprising both audio and video data and the identifier is inserted into an MPEG transport stream packet.

34. The system of claim 21 wherein the subscription information includes at least one of:
subscription information of a creator of the media content;
subscription information of a contributor of the media content;
subscription information of a sender of the media content; and
subscription information of at least a subset of receivers of the media content.

35. The system of claim 34 wherein presenting the subscription information includes at least one of displaying the subscription information associated with the media content in response to a request to play the media content, printing the subscription information, and playing an audio reproduction of the content of the subscription information while the media content is played.

36. The system of claim 21 wherein the media content includes audio data having multiple tracks and multiple identifiers stored in the metadata are associated with respective tracks, wherein the subscription information associated with each of the tracks is presented when each of the tracks is played.

37. The system of claim 21 wherein the subscription information includes at least one of a status that conveys status information and a communication address.

38. The system of claim 37 wherein the communication address specifies at least one contact means and at least one corresponding contact address associated with the subscription information.

39. The system of claim 37 wherein a communication channel is automatically opened using the communication address.

40. The system of claim 23 wherein using the identifier to associate subscription information with the media content includes using the identifier as an index to retrieve a subscription URL from a cross-reference database if the identifier is not of a type sufficient to directly obtain the subscription information, and then using the subscription URL to obtain the subscription information.

41. An executable software product stored on a computer-readable medium containing program instructions for associating subscription service information with media content, the program instructions for:
receiving the media content including an identifier of a subscription service associated with the media content;
using the identifier to subscribe to a subscription service using a publish/subscribe protocol;
receiving information associated with the subscription service via the publish/subscribe protocol based on the subscription; and
presenting the subscription information along with the media content.

42. A computer-implemented method for associating subscription service information with media content, comprising:
embedding into the media content an identifier of a subscription service associated with at least a portion of the media content, wherein the identifier is embedded by at least one of a provider of the media content and a publish/subscribe service;
making the media content with the identifier available to a computing device of a receiver so that the computing device can,
use the identifier to subscribe to a subscription service using a publish/subscribe protocol;
receive information associated with the subscription service via the publish/subscribe protocol based on the subscription; and
present the subscription information along with the media content.
